(19) United States
(12) Patent Application Publication
(10) Pub. No.: US 2009/0084639 A1
(43) Pub. Date: Apr. 2, 2009

(54) BICYCLE BRAKE SYSTEM

(76) Inventor: James Colegrove, Lake Mills, WI (US)

Correspondence Address: BOYLE FREDRICKSON S.C., 840 North Plankinton Avenue, MILWAUKEE, WI, 53203, US

(21) Appl. No.: 11/865,425

(22) Filed: Oct. 1, 2007

(51) Int. Cl. F16D 65/12; B62L 5/00; F16D 55/22

(52) U.S. Cl. 188/26; 188/218 XL; 188/73.31

(57) ABSTRACT

A brake system for a bicycle includes a number of brake members constructed to engage one another, such as a rotor and a shoe or pad. At least one of the brake members includes fiber reinforcing members. The fiber reinforcing members are distributed throughout the brake member and communicate the braking loads across a substantial portion of the brake member. The braking member is further constructed to distribute the heat associated with a braking action in a generally uniform manner across the brake member. Preferably, the brake member is formed with carbon-type fibers suspended in a Bismaleimide type material. Such a construction provides a powerful, lightweight and robust brake system.

### BACKGROUND OF THE INVENTION

The present invention relates generally to bicycles and, more particularly, to bicycles having fiber reinforced, lightweight and robust brake assembly components.

The primary structural component of a conventional two-wheel bicycle is the frame. On a conventional road bicycle, the frame is typically constructed from a set of tubular members assembled together to form the frame. For many bicycles, the frame is constructed from members commonly referred to as the top tube, down tube, seat tube, seat stays and chain stays, and those members are joined together at intersections commonly referred to as the head tube, seat post, bottom bracket and rear dropout. The bottom bracket usually comprising a cylindrical member for supporting the pedals and chain drive mechanism which powers the bicycle. The seat tube usually functions to telescopically receive a seat post for supporting a seat or saddle for the bicycle rider to sit on. The pedals, seat, and handlebars communicate rider forces to the frame and vice versa.

During a ride, the wheels rotate and propel the bicycle along the ground. Understandably, it is often desired to slow or stop the forward motion of the bicycle. Bicycle brake systems traditionally included a caliper constructed to compress opposing side walls of a wheel or tire of the bicycle. The caliper generally includes one or more replaceable or consumable pads, or brake pads, that frictionally engaged the wheel or tire and resist rotation of the wheel relative to the bicycle frame thereby slowing or stopping the bicycle.

Subsequently, more hub concentric mounted braking systems, specifically, disc brake systems, were developed. The hub mounted disc braking systems generally include a rotor or disc that is secured to the wheel hub and a caliper secured to the bicycle frame. Due to close proximity of the caliper to the axis of rotation of the wheel, the caliper is commonly secured along the length of a fork tube for front wheel braking systems and along a seat stay or chain stay for rear wheel braking systems.

Considerable energy must be consumed by and/or communicated through the braking system components to ensure adequate bicycle braking performance. The discs and pads of known rotor wheel assemblies are generally constructed of metallic materials such as steel, aluminum, titanium or other metal materials due to the forces and heat commonly associated with braking operations. The mass of these braking assemblies is generally considerable to ensure that the components of the braking system are of sufficient size and shape to withstand the braking forces and power. During aggressive and/or competitive riding, it is often desired to provide small and/or lightweight brake assemblies.

Although simply reducing the size of the braking components would reduce the mass of the braking system, this solution has proven unfeasible to achieve the mass and braking performance desired. That is, resolving brake rotor and pad construction to satisfy both weight and performance specifications has proven to be more than routine. Simply reducing the thickness and/or size of the rotors and pads has produced many unsatisfactory brake systems. The detrimental features of such brake systems include rotor that have unsatisfactory life cycles, rotors rendered inoperable due to thermal deformations or surface hardening, and/or critical failure due to cracks or the like due to the inability to properly withstand bicycle braking forces and/or power. Meanwhile, rotor brake systems that accommodate these performance requirements are unsatisfactory in as much as they are generally not very compact and increase the operating mass of the bicycle.

Accordingly, it would be desirable to provide a bicycle braking system and method of providing a bicycle braking system that is robust and yet lightweight. It would further be desirable to provide such a bicycle brake assembly such that it can be economically manufactured and efficiently integrated into any of a number of bicycle configurations and/or bicycle types such as cross country, down hill, mountain, and street or city bike products.

### BRIEF DESCRIPTION OF THE INVENTION

The present invention provides a system and method of forming a bicycle brake system that overcomes one or more of the aforementioned drawbacks. One aspect of the invention includes a bicycle brake assembly wherein at least one of a brake pad and a brake rotor are formed of a fiber based material. The fibers are generally uniformly distributed throughout the brake member, and transmit the braking forces to the bicycle frame. Such a construction provides a bicycle brake system that is powerful, lightweight, compact, and robust.

Another aspect of the invention discloses a bicycle brake system that includes a rotor, a caliper, and at least one brake pad. The rotor is securable to a hub of a bicycle wheel and includes a generally planar braking section. The caliper is securable to a bicycle such that at least one brake pad is positioned adjacent the braking section of the rotor. The caliper is operable to selectively move the pad into contact with the rotor. A number of fibers are distributed throughout at least one of the rotor and the pad and allow the rotor to withstand the heat and forces of a braking operation. Such a construction provides a compact and lightweight bicycle brake system.

A further aspect of the invention includes forming the fibers from one or more of carbon fibers, glass fibers, aramid fibers, boron fibers, basalt fibers, ultra high molecular weight polyethylene (UHMWPE), also known as high modulus polyethylene (HMPE) or high performance polyethylene (HPPE), aliphatic polymer based fibers such as Dyneema, polybenzoxazole (PBO) fibers, Spectra® fiber, a liquid crystal polymer fiber formed from an aromatic polyester such as Vectran, etc. The fibers or reinforcements are generally uniformly suspended about the circumference of the rotor in a resin matrix material that includes but is not limited to one or more of a thermoset resin, a thermoplastic system, an epoxy, polyimide, polyamide, Bismaleimide, PEEK, Torlon, a ceramic matrix, or Ultem.

Yet another aspect of the invention discloses a bicycle having a frame, a seat attached to the frame for supporting a rider, a pair of wheels rotationally connected to the frame, and a brake assembly. The brake assembly includes a first brake member that is secured to one of the wheels. A caliper is secured to the frame proximate the first brake member. A second brake member is attached to the caliper for selectively engaging the first brake member. A number of fibers are suspended in at least one of the brake members for distributing heat and stresses generated during a braking operation. Such a construction provides a lightweight bicycle assembly equipped with a rotor braking system.

A further aspect of the invention discloses a method of providing a bicycle brake system. The method includes providing a caliper constructed to be secured to a bicycle frame. A pad[s] is attached to the caliper. A rotor is provided that has a number of fibers distributed throughout a cross-sectional area of the rotor. The rotor is constructed for being secured to a wheel such that the rotor rotates about a common axis with the wheel. The rotor is attached to the wheel such that a brake area of the rotor rotates past the pad[s] such that braking forces and braking heat are transmitted and conducted along the circumferential and radial area of the rotor.

It is appreciated that these aspects are not mutually and/or individually exclusive with respect to one another. These and various other aspects, features, and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevational view of the bicycle equipped with front and rear brake assemblies according to the present invention;

FIG. 2 is an elevational view of a rotor removed from one of the brake assemblies shown in FIG. 1;

FIG. 3 is a cross-sectional view a portion of the rotor shown in FIG. 2; and

FIG. 4 is an elevational view of another rotor according to the present invention and having a geometry that is different than the geometry of the rotor shown in FIG. 2.

### DETAILED DESCRIPTION OF THE PREFERRED EMBODIMENT

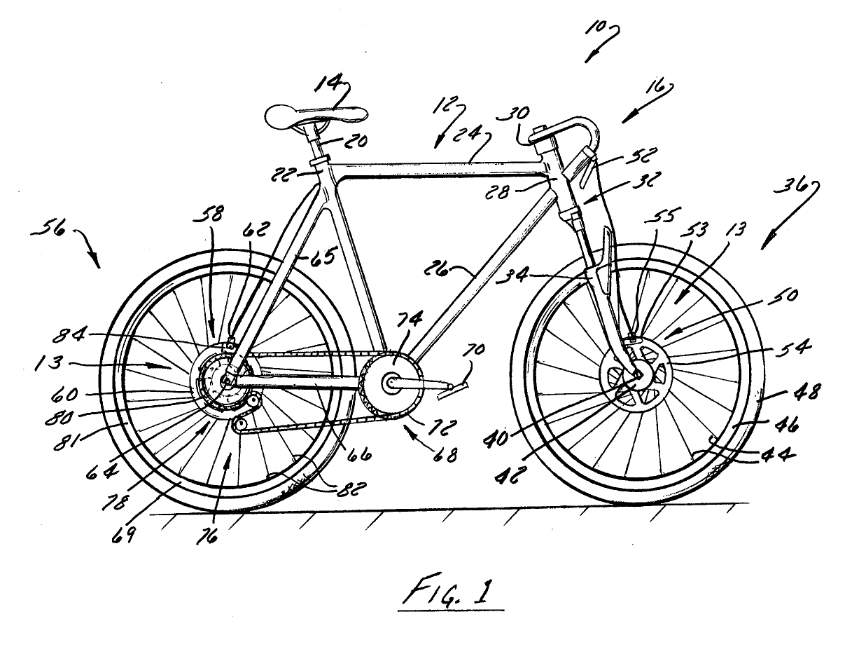

FIG. 1 shows a bicycle 10 equipped with a pair of brake assemblies 13 according to the present invention. Bicycle 10 includes a seat 14 that is preferably slidably attached to frame 12. A seat post 20 is connected to seat 14 and slidably engages a seat tube 22 of frame 12. A top tube 24 and a down tube 26 extend forwardly from seat tube 22 to a head tube 28 of frame 12. A handlebar assembly 16 is connected to a stem tube 30 that passes through head tube 28 and engages a fork crown 32. The position of handlebar assembly 16 is fixed relative to stem tube 30 and fork crown 32 such that handlebar assembly 16 and fork crown 32 rotate together relative to head tube 28.

Bicycle 10 includes a front brake assembly 50 having an actuator 52 attached to handlebar assembly 16. Front brake assembly 50 includes caliper 55 having a pair of shoes or brake pads 53. Brake pads 53 are oriented to be positioned on generally opposite sides of a brake disc or rotor 54 which is secured to front wheel assembly 36. Caliper 55 is secured to fork 34 thereby fixing the position of caliper 55 relative to brake rotor 54. Brake rotor 54 is secured to front wheel assembly 36 proximate hub 42. Caliper 55 is constructed to bias pads 53 into engagement with rotor 54 upon manipulation of actuator 52. Brake pads 53 frictionally engage rotor 54 and thereby provide a slowing or stopping force to front wheel assembly 36.

A rear wheel assembly 56 also includes another disc brake assembly or rear brake assembly 58 having a rotor 60 and a caliper 62 that are positioned proximate a rear axle 64. A rear wheel 69 is positioned generally concentrically about rear axle 64. Understandably, either one or both of front and rear wheel assemblies 36, 56 could be provided with rotor or disc-type brake assemblies.

A seat stay 65 and a chain stay 66 offset rear axle 64 from a crankset 68. Crankset 68 includes a pedal 70 that is operationally connected to a chain 72 via a chain ring or sprocket 74. Rotation of chain 72 communicates a drive force to a rear section 76 of bicycle 10 having a gear cluster 78 positioned thereat. Gear cluster 78 is generally concentrically orientated with respect to rear axle 64 and includes a number of variable diameter gears.

Gear cluster 78 is operationally connected to a hub 80 of rear wheel 69. A number of spokes 82 extend radially between hub 80 and a rim 81 of rear wheel 69 of rear wheel assembly 56. As is commonly understood, rider operation of pedals 70 drives chain 72 thereby driving rear wheel 69 which in turn propels the rider of bicycle 10. The full weight and force of the rider is communicated to frame 12 of bicycle 10 through peddles 70, seat 14, and handlebar assembly 16. During aggressive riding, the rider occasionally assumes an elevated position such that only peddles 70 and handlebar assembly 16 support rider interaction with bicycle 10.

As shown, caliper 62 of rear wheel assembly 56 is secured to seat stay 65. It is envisioned that caliper 62 be secured to other structures of bicycle 10 such as either one of the oppositely facing chain stays 66. It is desired that caliper 62 be fixed to bicycle 10 such that rotor 60 of rear brake assembly 58 rotate between oppositely facing pads 84 associated with caliper 62. Caliper 62 is also operatively connected to an actuator (not visible) proximate handlebar assembly 16. Alternatively, actuator 52 could be configured to allow rider operation of both of the front and rear wheel brake assemblies 50, 58. It is further envisioned that calipers 55, 62 are any of mechanically (such as via a cable or the like), electrically, pneumatically, or hydraulically operable. Regardless of the operating modality, rider manipulation of actuator(s) 52 biases one or more pads 53, 84 into engagement with an associated rotor 54, 60 thereby imparting a stopping force to bicycle 10.

FIG. 2 shows a rotor 86 that is one of rotors 54, 60, removed from bicycle 10. Rotor 86 includes a body 88 having a number of passages formed therethrough. A first passage 90 is constructed to generally cooperate and align rotor 86 with a respective hub 42, 80 of a respective wheel assembly 36, 56. A number of holes 92 are positioned radially outward from opening 90 and are configured to cooperate with a fastener for securing rotor 86 to a respective wheel assembly 36, 56. Preferably, holes 92 are sequentially and circumferentially and radially equidistantly positioned about opening 90. Such a construction ensures the generally uniform transmission of braking forces to a respective hub 42, 80 of a respective wheel assembly 36, 56.

Alternatively, a variety of different means of attaching rotor 86 to a respective wheel assembly 36, 56 are appreciated and within the scope of the claimed invention. That is, it is understood that wheel assemblies 36, 56 may include a rotor secured about a hub or a rim and that the securing means may be positioned radially inward or outward relative to the braking surface of the rotor. It is further appreciated that the securing means may be provided as fasteners as shown or as splined mating orientation configured to secure the rotor relative to the wheel. It is further appreciated that although rotor 86 is shown as having a generally planar braking surface, the braking surface may be provided other rotatable contours. A number of passages 94 are formed through body 88 and positioned radially outward relative to holes 92. Passages 94 reduce the amount of material consumed by the formation of rotor 86 and allow air to flow through body 88 during operation of bicycle 10. Such a construction reduces the impact of rotor 86 on crosswind aerodynamic performance of bicycle 10. Furthermore, the flow of air through passages 94 enhances the air cooling of rotor 86 during braking operations. Body 88 of rotor 86 includes brake faces 96 that are positioned on generally opposite sides of rotor 86 between passages 94 and a circumferential perimeter 98 of rotor 86. As used herein, brake faces 96 are those portions of adjacent structures that are intended to be selectively engageable with one another, i.e. those portions of pads 53, 84 and rotors 54, 60, 86 that contact one another during braking operations.

A number of arms 100 extend between brake faces 96 and an interior portion 102 of body 88. Arms 100 are constructed and oriented to generally uniformly transmit thermal and brake force loading imparted to brake faces 96 to interior portion 102 of body 88. Understandably, arms 100 and passages 94 could be provided in any of a number of configurations and orientations. That is, the size and shape of arms 100 and passages 94 could be provided in unlimited configurations. Regardless of the configuration of the arms and passages, the braking forces transmitted to interior portion 102 of rotor 86 are transmitted from rotor 86 to a respective hub of bicycle 10. The forces are communicated from the hub to frame 12 of bicycle 10 thereby providing a generally uniform and stable desired braking operation. Regardless of the orientation of the rotor relative to the wheel, i.e. such as those configurations wherein the rotor is secured to the wheel remote from the hub, the braking forces are efficiently communicated from the wheel to the frame of the bicycle.

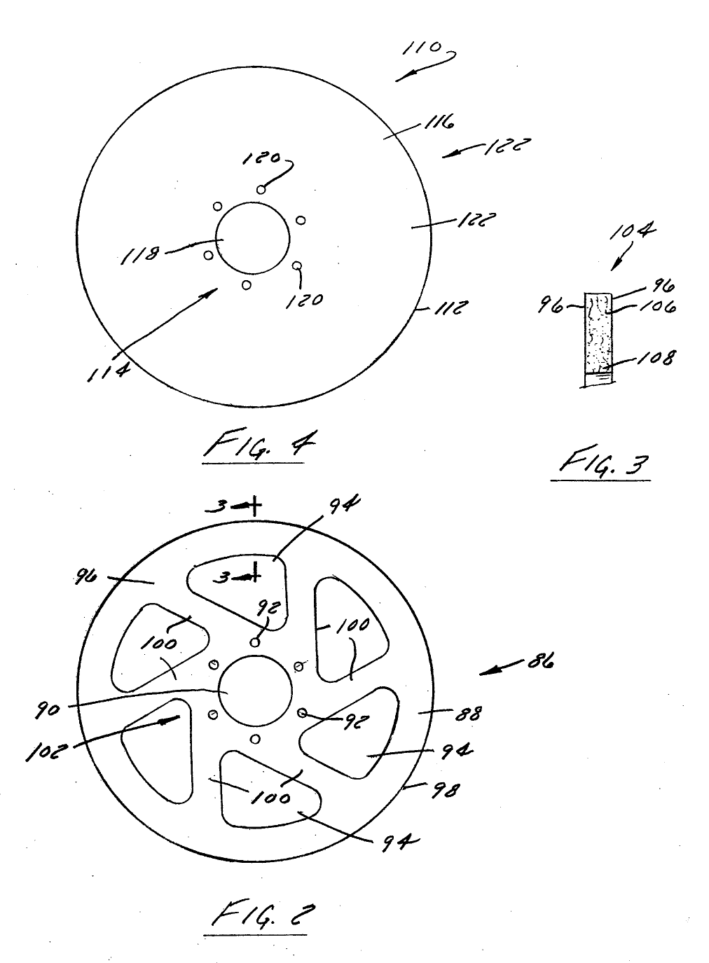

FIG. 3 shows a representative cross-section of a brake member 104 according to the present invention. As used herein, brake member 104 includes any of the respective brake assembly components constructed to selectively engage one another. That is, it is envisioned that any of rotors 54, 60, 86 and pads 53, 84 be constructed in accordance with the construction of brake member 104. For purposes of example only, brake member 104 of FIG. 3 is discussed further below as being representative of that portion of a rotor as indicated by line 3-3 in FIG. 2.

Brake member 104 includes a body 88 that extends between a pair of brake faces 96. Understandably, when brake member 104 is provided as a brake pad 53, 84, brake member 104 may have only one brake face. A number of fibers 106 are suspended through body 88 of brake member 104. Fibers 106 may be any of carbon, glass, aramid, boron, basalt, ultra high molecular weight polyethylene (UHMWPE), also known as high modulus polyethylene (HMPE) or high performance polyethylene (HPPE), aliphatic polymer based such as Dyneema, polybenzoxazole (PBO) based, Spectra® brand fiber, a liquid crystal polymer fiber formed from an aromatic polyester such as Vectran, or other material based fibers. Preferably, fibers 106 are carbon based fibers whose position is ensured by a suspension or resin matrix 108 that forms a substantial portion of body 88.

It is envisioned that resin matrix 108 may be provided as one or more of a thermo-set and/or thermoplastic resin systems, an epoxy, a polyimide, a polyamide, Bismaleimide, polyketones (PEEK), polyamide-imide (such as Torlon®), a ceramic matrix, and/or generally amorphous polymers, such as Ultem's. Preferably resin matrix 108 is not pyrolized or carbonized either during formation or operation of brake member 104. Braking member 104 can be formed by any or a combination of OCLV (optimum compaction, low void) molding, compression molding, vacuum bag molding, autoclave molding, resin transfer molding, infusion molding, and/or injection molding. It is further envisioned that the desired brake member 104 be formed with a water jet cutting operation or CNC machining or net molding. Preferably, brake member 104 includes a carbon based fiber 106 suspended in a high service temperature epoxy or a Bismaleimide (BMI) resin 108. More preferably, the carbon based fiber 106 is formed of uni-directional carbon fiber and/or woven (cloth) carbon fiber, either 2-D woven or 3-D woven. Regardless of the specific construction and orientation of the carbon fiber 106 relative to resin matrix 108, such a construction provides for the efficient production of a number of braking members that are configured to cooperate with existing bicycle brake systems.

The compound material construction of brake member 104 allows brake member 104 to withstand the forces and heat generated during a bicycle braking operation. A bicycle rotor assembly such as that disclosed herein reduces the mass of bicycle 10 by approximately 70 grams or more than ½ of the mass associated with a comparable rotor constructed of a steel-type material. Rotor 54, 60 constructed in accordance with the present invention can achieve a finish product weight of approximately 43 to 64 grams, depending on the desired operating range of the rotor (commonly six inch or 160 mm diameter rotors). A steel rotor constructed for operation under comparable conditions and with comparable equipment has been shown to be considerably heavier at a weight of approximately 103 grams. The reduction in mass of the brake assembly further increases the number of bicycle types with which brake member 104 is operable and the range of riders to whom the brake assemblies will be acceptable.

FIG. 4 shows another brake member 110 constructed according to the present invention. As shown, brake member 110 forms a rotor having a circumferential perimeter 112 and a hub area 114 generally centrally positioned in a body 116 of brake member 110. Hub area 114 includes a first opening 118 for accommodating an axle of bicycle 10 and a number of openings 120 positioned radially about opening 118. Openings 120 are oriented to cooperate with a number of fasteners for securing body 116 of brake member 110 to a wheel. As compared to brake member 86, brake member 110 has a substantially planar and continuous brake area 122 that extends between openings 120 and perimeter 112. Understandably, the construction of brake area 122 could be adjusted or otherwise varied as determined by the engagement of corresponding brake pads. The construction of body 116 of brake member 110 is substantially similar to brake member 104 as described above other than the geometric shape of the brake member. It is appreciated that brake members 86, 104, 110 could be provided in generally any shape, size, and configuration. It is further appreciated with the specific features of any of brake members 86, 104, 110 can be relatively easily varied to satisfy any desired size, shape, and configuration of brake members 86, 104, 110. Regardless of the desired shape and relative operational location of brake member 86, 104, 110, the construction of brake members 86, 104, 110 provides lightweight and robust bicycle brake system components that can withstand the rigors associated with bicycle operation including the force and power generated during aggressive braking. Brake members 86, 104, 110 are constructed to withstand the forces and power and temperature associated with braking during aggressive riding and reduce the weight of the bicycle assembly as compared to other bicycle brake systems. Accordingly, brake members 86, 104, 110 contribute to a powerful, lightweight and robust bicycle brake assembly.

Therefore, one embodiment of the invention includes a bicycle brake system having a rotor that is securable to a hub of a bicycle wheel. The rotor includes a generally planar braking section. A caliper having at least one pad is securable to a bicycle such that the at least one pad is positioned adjacent the braking section of the rotor. The caliper is operable to selectively move the pad into contact with the rotor. A number of fibers are distributed throughout at least one of the rotor and/or the pad of the bicycle brake system.

Another embodiment of the invention includes a bicycle having a frame, a seat attached to the frame for supporting a rider, and a pair of wheels rotationally connected to the frame. A first brake member is secured to one of the wheels and a caliper is secured to the frame proximate the first brake member. A second brake member is attached to the caliper for selectively engaging the first brake member. A number of fibers are suspended in at least one of the brake members for distributing heat and forces generated during a braking operation.

A further embodiment of the invention includes a method of providing a bicycle brake system. The method includes providing a caliper constructed to be secured to a bicycle frame. A pad is attached to the caliper and a rotor is provided that includes a number of fibers distributed throughout a cross-sectional area of the rotor. The rotor is further constructed for being secured to a wheel such that the rotor rotates about a common axis with the wheel. The rotor is attached to a wheel such that a brake area of the rotor rotates past the pad such that braking forces and braking heat are communicated along the circumferential and radial area of the rotor.

The present invention has been described in terms of the preferred embodiment, and it is recognized that equivalents, alternatives, embodiments, and modifications, aside from those expressly stated, are possible and within the scope of the appending claims. It is further understood and appreciated that the various aspects, features, and embodiments disclosed herein are not solely or mutually exclusive.

What is claimed is:

1. A bicycle brake system comprising:
a rotor securable to a hub of a bicycle wheel, the rotor having a surface of revolution that forms a braking section;
a caliper having at least one pad and securable to a bicycle such that the at least one pad is positioned adjacent the braking section, the caliper being operable to selectively move the pad into contact with the rotor; and
a number of fibers distributed throughout at least one of the rotor or the pad.

2. The bicycle brake system of claim 1 wherein the number of fibers are formed as at least one of carbon fibers, glass fibers, aramid fibers, basalt fibers, ultra high molecular weight polyethylene (UHMWPE) fibers, high modulus polyethylene (HMPE) fibers, high performance polyethylene (HPPE) fibers, aliphatic polymer based fibers, polybenzoxazole (PBO) based fiber, Spectra® brand fiber, a liquid crystal polymer fiber formed from an aromatic polyester, or boron fibers.

3. The bicycle brake system of claim 1 wherein the fibers are distributed throughout the rotor and the distribution of the fibers assists in the transmission of braking heat and braking force.

4. The bicycle brake system of claim 1 wherein the fibers are suspended in at least one of a thermo-set resin, a thermoplastic system, an epoxy, polyimide, polyamide, Bismaleimide, polyketones, polyamide-imide, a ceramic matrix, or Ultem.

5. The bicycle brake system of claim 1 wherein the rotor has a size and a shape with a radial width that is greater than an axial thickness and the fibers are distributed through the rotor based on the size and shape.

6. The bicycle brake system of claim 1 wherein the number of fibers are suspended in a body formed by one of OCLV molding, compression molding, vacuum molding, autoclave molding, resin transfer molding, infusion molding or injection molding.

7. The bicycle brake system of claim 1 further comprising a number of fasteners passing through the rotor and securing the rotor to the hub, each fastener being at least one of radially offset of the braking section or received in a cavity formed in the rotor such that the fastener does not extend beyond a braking face of the rotor.

8. The bicycle brake system of claim 1 wherein the fibers are selected and oriented throughout the rotor such that the rotor can withstand heat and forces associated with a bicycle braking operation.

9. A bicycle comprising:
a frame;
a seat attached to the frame for supporting a rider;
a pair of wheels rotationally connected to the frame;
a first brake member secured to one of the wheels;
a caliper secured to the bicycle proximate the first brake member;
a second brake member attached to the caliper for selectively engaging the first brake member; and
a number of fibers suspended in at least one of the brake members for distributing heat and forces generated during a braking operation.

10. The bicycle of claim 9 wherein the fibers are suspended in the first member and the first member has a rotor shape.

11. The bicycle of claim 10 wherein the rotor shape has an axial thickness that is substantially less than a radial width of a braking surface of the first member.

12. The bicycle of claim 9 wherein the fibers are formed of a carbon type material.

13. The bicycle of claim 9 wherein the fibers are formed of a glass type material.

14. The bicycle of claim 9 wherein the fibers are formed of an aramid type material.

15. The bicycle of claim 9 wherein the fiber are formed of a boron type material.

16. The bicycle of claim 9 wherein the fibers are formed from one or more of basalt fibers, ultra high molecular weight polyethylene (UHMWPE) fibers, high modulus polyethylene (HMPE) fibers, high performance polyethylene (HPPE) fibers, aliphatic polymer based fibers, polybenzoxazole (PBO) based fiber, Spectra® brand fiber, and a liquid crystal polymer fiber formed from an aromatic polyester.

17. The bicycle of claim 9 wherein the number of fibers are fixed in space in a resin matrix of Bismaleimide.

18. A method of providing a bicycle brake system comprising:
providing a caliper arranged to transmit braking forces to a bicycle frame;
attaching a pad to the caliper;
providing a rotor having a number of fibers distributed throughout a cross-sectional area of the rotor constructed for being secured to a wheel such that the rotor rotates about a common axis with the wheel; and
attaching the rotor to a wheel such that a brake area of the rotor rotates past the pad such that braking forces and braking heat are communicated through a Bismaleimide body along the area of the rotor.

19. The method of claim 18 further comprising randomly distributing the number of fibers throughout the rotor.

20. The method of claim 18 further comprising organizing at least a portion of the number of the fibers relative to one another and relative to their respective location in the rotor.

21. The method of claim 18 further comprising selecting the number of fibers to include fibers of at least one of carbon fibers, glass fibers, aramid fibers, boron fibers, basalt fibers, ultra high molecular weight polyethylene (UHMWPE) fibers, high modulus polyethylene (HMPE) fibers, high performance polyethylene (HPPE) fibers, aliphatic polymer based fibers, polybenzoxazole (PBO) based fiber, Spectra® brand fiber, a liquid crystal polymer fiber formed from an aromatic polyester.
